(19) United States
(12) Patent Application Publication
(10) Pub. No.: US 2004/0003507 A1
(43) Pub. Date: Jan. 8, 2004

(54) Conduit layout tool

(76) Inventors: David Scott Jordan, Albuquerque, NM (US); Michael Calvin Jordan, Albuquerque, MN (US)

Correspondence Address: David S. Jordan, 11024 MOTGOMERY NE #213, Albuquerque, NM, 87111, US

(21) Appl. No.: 10/189,496

(22) Filed: Jul. 8, 2002

(51) Int. Cl. B43L 7/00

(52) U.S. Cl. 33/566

(57) ABSTRACT

An electrician's conduit layout tool to facilitate placing conduit holes in electrical boxes wherein a small rectangular tool is provided having marking point for both sizes of strut, all parallel conduit marking locations in its peripheral edge and center marking locations for all conduit sizes on a one piece durable Tool. A three step method is used to layout any combination of conduits with no calculations. Is also used in strut rack layout parallel conduit marking locations in its peripheral edge. A panel schedule is also etched into the conduit layout tool for a wire-pulling guide. Lines are drawn through the center of the circumferential trace to facilitate the positioning of a conventional knockout.

### BACKGROUND OF THE INVENTION

1. Field of the Invention (Technical Field):

The present invention relates to the field of measurement tools, in particular a measurement tool for accurately placing conduits extending along a wall and into a panel box.

Field of search 33/1 G,516,520,528,529,644,671,DIG. 10

2. Background Art

Conduits of various materials are used to enclose and protect electrical wiring running along the vertical surface of walls. These conduits often junction into an electrical panel box so that the electrical connections can be made. (See FIG. 6.) The conduits are held securely to the wall by strut straps which wrap around the conduits and are in turn attached to a strut mounting brace that is affixed to a surface for two standard size struts ⅞″ and 1⅝″. The strut straps are sized differently for different sized conduits. In order to install the conduits into the panel box, the electrician must make several measurements onto the top surface of the panel box to mark the location of each conduit, so that the top surface of the panel box can be cut or drilled through for receiving the conduit.

First, the electrician must determine the width of the strut installed above the panel box, for example, whether the strut is ⅞″ or 1⅝″. Next, the electrician must determine how far out to drill the center of the hole for each conduit, as well as how far apart the conduits must be spaced. These measurements are critical because the conduit must fit up against the strut, and there must be space available for the couplings and hardware to attach the conduit to the panel box. The conduits must be spaced so that there is ample room for each conduit going into the panel box.

A tool is needed to eliminate the repetitive measuring and mathematical calculations required to mark the locations on the panel box for each conduit. Such a tool would simplify the task, increase the efficiency of the electrician, and increase the accuracy of conduit placement.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a top view of the top surface of the conduit layout tool showing the marking locations to be used with ⅞″ or 1⅝″ strut;

FIG. 2 is the layout tool of FIG. 1 showing the marking locations to be used for center-to-center locations of conduit combinations;

FIG. 3 is a side view of edge A of the conduit layout tool of FIGS. 1 and 2 showing the folded edge that wraps around an edge of the electrical panel box for guiding the tool;

FIG. 4 is a side view of edge B of the conduit layout tool of FIGS. 1 and 2;

FIG. 5 is a top view of the bottom surface of the conduit layout tool of FIGS. 1 and 2 showing marking locations to be used when there is no strut and the panel schedule used as a pocket reference for wire pulling;

FIG. 6 is a perspective view of conduits, strut, electrical panel box, and the conduit layout tool being guided along a rear edge of the top surface of the electrical panel box;

FIG. 7 is a top view of the panel box top surface showing the reference line created by a 1⅝″ strut marking location and the adjacent positions of the conduit layout tool when installing a series of ½″ diameter conduits; and

FIG. 8 is a top view of the panel box top surface showing the reference line created by a 1⅝″ strut as well as the positioning of the conduit layout tool in Step 2 when marking a 4” conduit and adjacent 3″ conduit combination.

FIG. 9 is a top view of a panel surface showing the conduit layout tool in Step 3 Marking a 3″ and the other center points.

Referring to FIG. 10 this technical drawing shows the exact size to scale, hole locations, and the nomenclature used for production.

### DESCRIPTION OF THE PREFERRED EMBODIMENTS (BEST MODES FOR CARRYING OUT THE INVENTION)

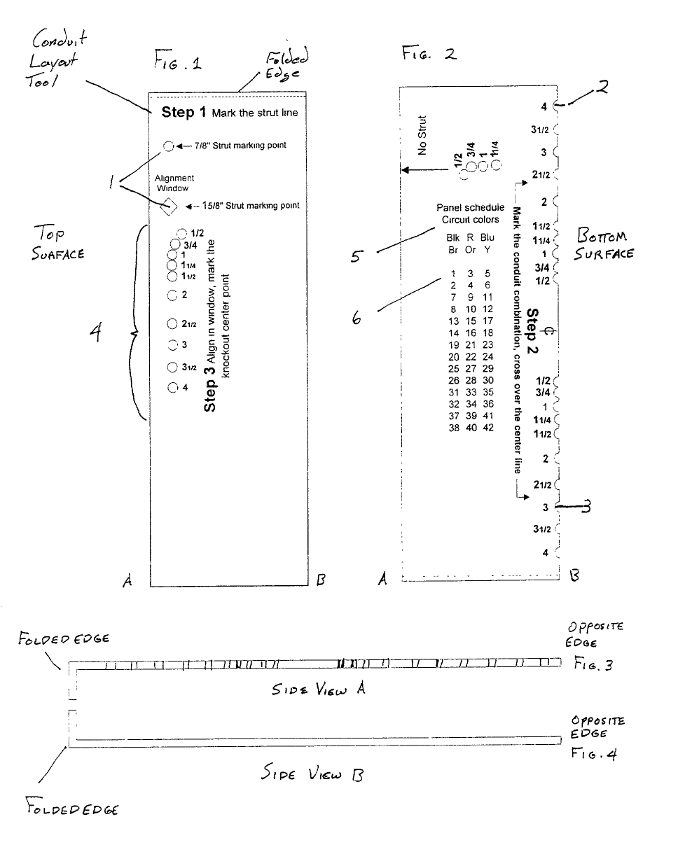

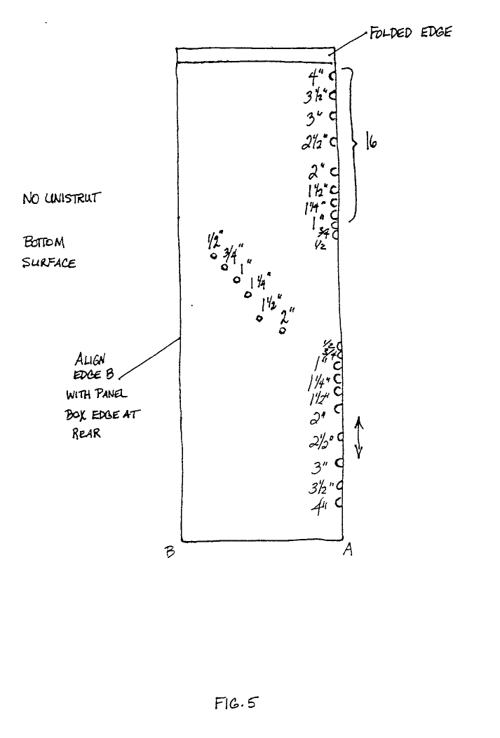

The present invention for a conduit layout tool solves the problem described above and provides an efficient means for electricians to layout the locations of conduits to be installed into an electrical panel box. This tool is used in three easy steps without the aid of other tools, measurements or any math calculations. This tool takes into account the standard trade sizes and measurements used world wide Referring to FIGS. 1, a top view of the top surface of the conduit layout tool is shown. FIG. 2 show the opposite side of the same conduit layout tool, but each provides different marking locations that are used in different steps. It is to be understood that two figures are provided rather than one for ease of reference to the marking locations. All markings locations shown on FIG. 1 and FIG. 2 are preferably on the same conduit layout tool. The layout tool is simply turned over in order to access the steps.

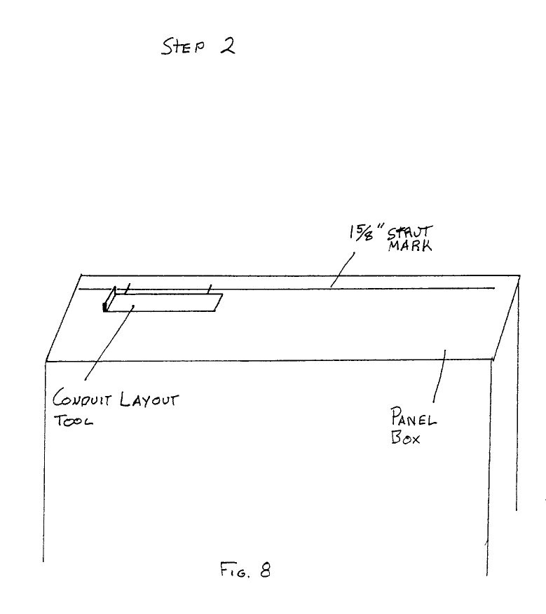

Referring first to FIG. 1, which is Step #1, a 7/8″ or 1⅝″ strut marking location can be seen at 1. Either location is a hole that extends through the surface of the conduit layout tool so that the electrician's pen or pencil can be fit through the hole to make a mark on a surface, such as the surface of the electrical panel box. Referring to FIG. 6, the conduit layout tool is shown as it is laid on the top surface of an electrical panel box. A folded edge at one end of the conduit layout tool wraps around an edge of the panel box defined by the upper surface and adjoining wall of the box to engage the tool in a relatively fixed position. When placed in this position, the conduit layout tool can easily slide to the left or right (see FIG. 6) with the electrician's pen held in the marking location hole. The conduit layout tool also facilitates the exact layout of conduit on strut racks up walls or ceilings due to the need to keep conduit as parallel as possible 1 (see FIG. 6)

First, the conduit layout tool is placed on the top surface of the electrical panel box as shown in FIG. 6, except that edge A is aligned with the left side of the panel box, Step #1 the electrician's pen is located into the ⅞″ or 1⅝″ strut marking location holes on the conduit layout tool, then the tool is slid along the rear edge of the electrical panel box so that a line is marked across the top of the electrical panel box in the horizontal direction of FIG. 6. This line provides guidance to the electrician for placement of the rear-most edge of each circular conduit to be installed into the electrical panel box.

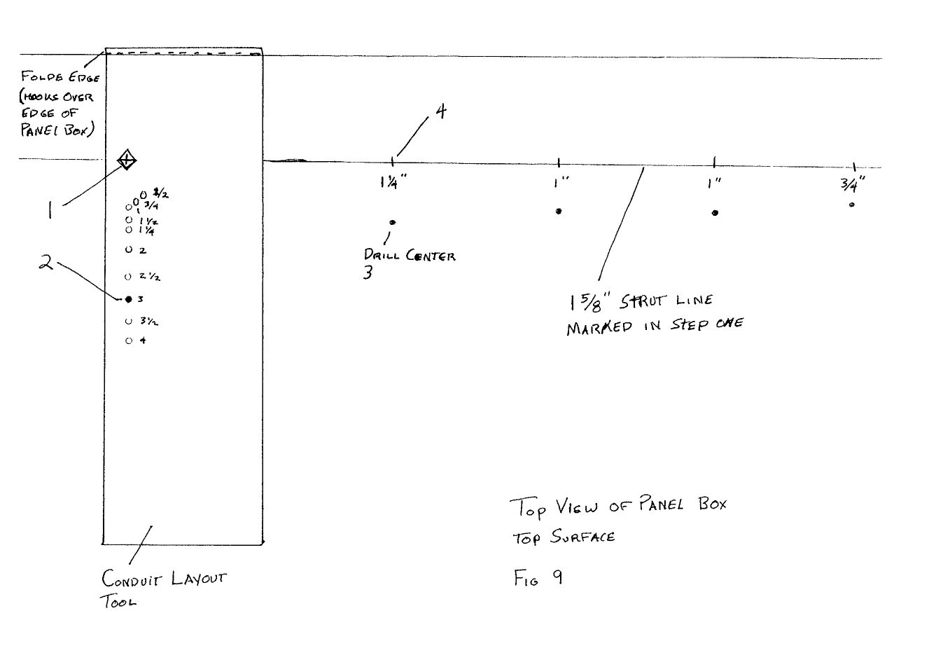

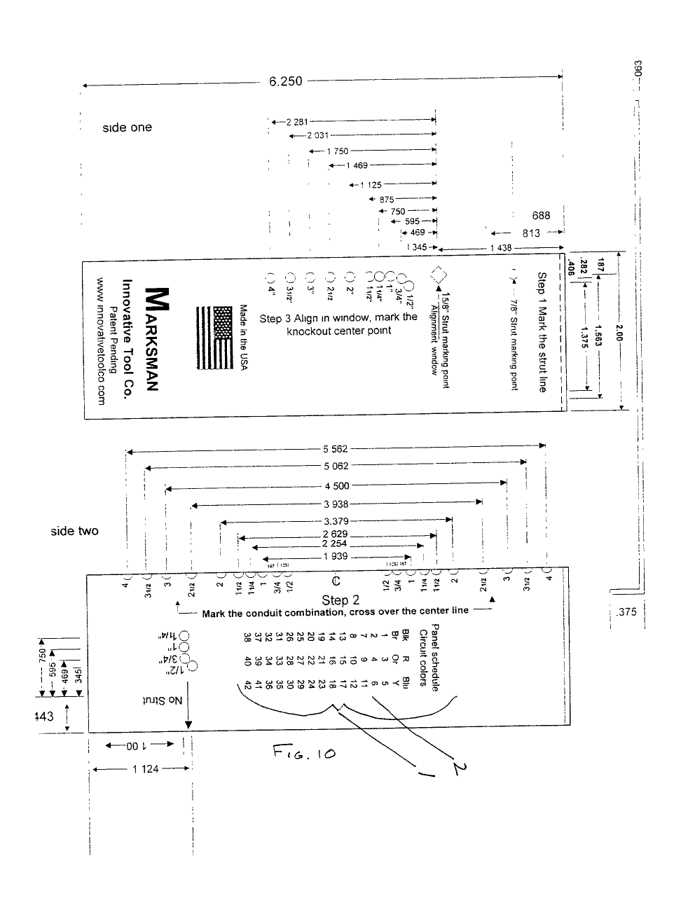

The remaining markings on the conduit layout tool aid the electrician in finding the locations for the center drill hole for each conduit to be installed into the panel box. For example, if a conduit combination of a 4″, 3″, 1¼″, 1″, 1″, and a ¾″ Step #2 1 FIG. 8 the conduit layout tool is placed on the top surface of the electrical panel box as shown in and the electrician places his pencil into the 4″ (See FIG. 7) marking location shown as 2 and makes a small mark. Next, without moving the conduit layout tool, the electrician makes a small mark in the location indicated at 3 crossing over the center line so as to not crowd the marking points (See also FIG. 7.) The mark made at the location indicated at 3 will be the center next slide the conduit layout tool over so that the last size marked lines up in the adjacent same size, mark the next size (See FIG. 7). This is repeated until all adjacent conduits are marked on the surface of the electrical panel box.

Step #3 (See FIG. 9) 1″ conduit placed adjacent to the first ¾″ conduit. By sliding the conduit layout tool to the left, guided by the folded edge wrapped around the rear edge of the panel box, until the marking location marked along the strut line 4 is positioned in the Alignment window FIG. 9 the mark made in the former location referred to as 3. Mark is then made in the marking location 2 FIG. 9 a 3″ and so on unfit all center drill holes are marked 3 (See FIG. 9)

Referring to FIG. 5, the bottom surface of the conduit layout tool is shown with marking holes used in applications where there is no strut retaining the conduit. In this application, the edge B of the conduit layout tool is aligned with the rear edge of the electrical panel box and the edge opposite the folded edge of the tool is aligned with the left side of the panel box. The center drill hole for the first conduit is marked in the marking location indicating its size. Next, a guideline for the size of the adjacent conduit is marked by placing the pen into the appropriate sized marking location and sliding the conduit layout tool along the top surface of the panel box in the direction indicated by the arrows, while maintaining the tool in alignment with the rear edge of the panel box. Then, in order to mark the location of the adjacent conduit, the conduit layout tool is positioned such that the edge A is aligned with the guideline that was just drawn and the first drill location is aligned with the first marking location on the bottom surface of the conduit layout tool. Next, the appropriate notch of the notches shown generally at 16 is used to mark the adjacent conduit center drill hole location on the guide line; i.e., this is done in much the same manner as was described with respect to FIG. 7 above

Referring to FIG. 10 this technical drawing shows the exact size to scale, hole locations, and the nomenclature used for production. Side two also has a set of numbers along with panel schedule circuit colors 1 with Blk, R, B, Brn, Or, Y, which refer to the colors black, red, blue, brown, orange, yellow these are colors used in the electrical industry voltage and circuit # indicators used on wire either as tape or as a plastic insulation on the exterior of wire. An electrician knowledgeable in the trade uses these colors as identifiers as to what panel the wire will be connected and what circuit it will be connected. Black, red, blue are 120-volt colors and respectively would be connected in a 120 v panel on the circuit indicated on the blue prints or plans for that particular structure. It is true in brown, orange; yellow these are 277-volt colors and respectively would be connected in a 277 v panel on the circuit indicated on the blue prints or plans for that particular structure. If for instance we had a 120 v panel servicing outlets in a structure we are going to pull new wire for circuit 11, (see FIG. 10) 2 look straight up the coulomb to the color indicated in this case it's blue, circuit one is black two is red etc. This color-coding of wire is used world wide for safety and efficiency during construction. The intention here is to provide a pocket reference not to limit the tool by exact colors and or nomenclature.

In an alternative embodiment, the 1⅝″ strut marking locations are located on the top surface of the conduit layout tool and the ⅞″ strut marking locations are located on the bottom surface of the conduit layout tool. In this embodiment, the “no strut” marking locations can be located on either of the top or bottom surfaces of the conduit layout tool. However, it is to be understood that the marking locations as described herein can be arranged in alternative configurations, and the size and shape of the conduit layout tool itself can take alternative configurations, and still achieve the purpose of the invention as will be understood by those skilled in the art,

In either the first or the alternative embodiment, the folded edge of the conduit layout tool is preferably detachable and attachable to either end of the conduit layout tool. The folded edge can be approximately ⅛″ in length away from the plane defined by the conduit layout tool and is attached by two or more attachments means, such as small bolts. The detachable folded edge is preferred in that the conduit layout tool can be guided along the edge of the panel box when using marking locations on either of the top or bottom surface, as well as when the conduit layout tool is positioned 180° for using the, for example, ⅞″ strut marking locations versus the 1⅝″ strut marking locations. Additionally, removing the detachable folded edge aids in marking the adjacent conduit locations for conduits larger than 1″ in diameter such as described with respect to FIG. 8 because the conduit layout tool is rotated 90° and is preferably laid flat and flush against the top surface of the panel box.

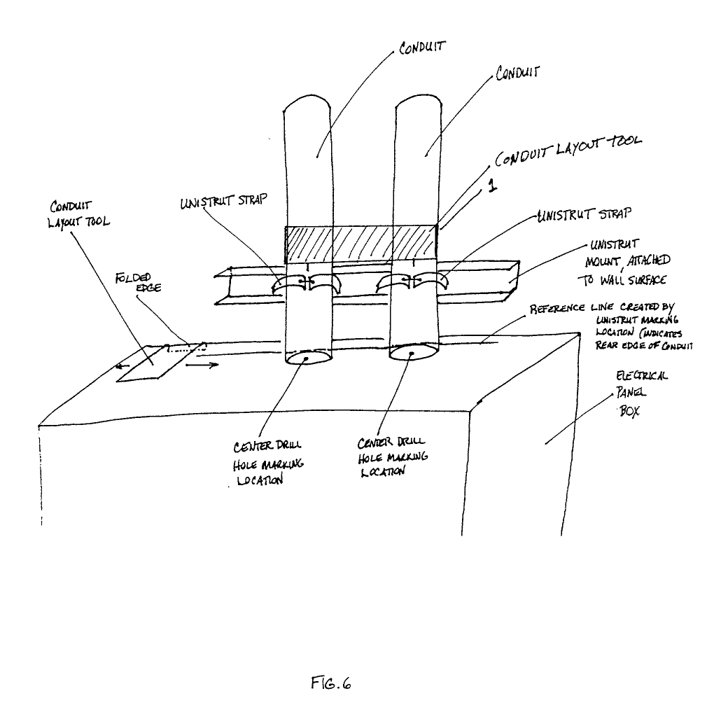

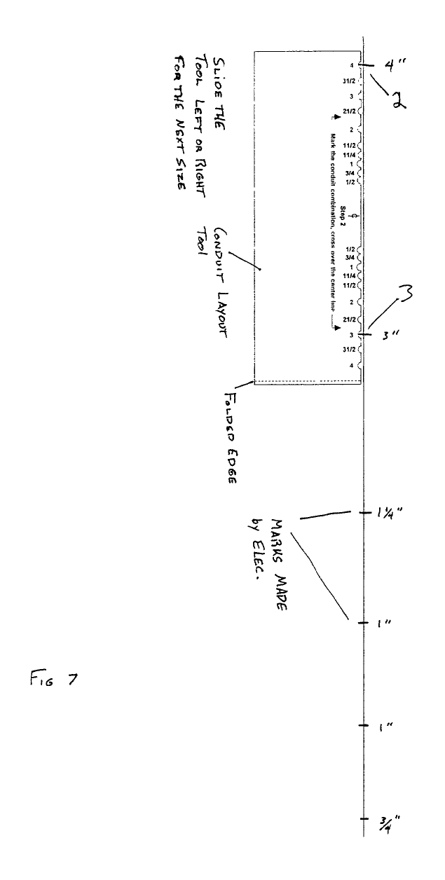

It is to be understood that the marking locations presented in FIGS. 1 through 9 are for purposes of standard sized conduits used in electrical winng, and the invention is not to be limited to these particular sizes. The conduit layout tool also has many applications beyond positioning electrical conduits into panel boxes, as will be understood by those of skill in the art. The conduit layout tool of the present invention provides a fast and accurate template for an electrician to follow in making these measurements Preferably, the conduit layout tool consists of a 6” piece of metal in length, such as aluminum, with the text of each marking location anodized and laser etched onto the tool.

The marking locations are preferably drilled through the tool, the size of each drilled hole large enough to accommodate a marking pen or pencil, the opening on the top surface where the pencil enters being larger and gradually diminishing in diameter to the opening on the opposite or bottom surface where the pencil will protrude through and mark the panel box so that the pencil is easily guided into the correct marking location.

Although the invention has been described in detail with particular reference to these preferred embodiments, other embodiments can achieve the same results. Variations and modifications of the present invention will be obvious to those skilled in the art and it is intended to cover all such modifications and equivalents.

We claim:

1. An electrician's conduit layout tool to facilitate placing conduit holes in electrical boxes comprising, of a rectangular tool small enough to fit in a pocket and durable enough to carry in the bottom of a tool bag. Wherein a three-step method is used to layout conduit entry locations.
A) Step one mark the strut line, by placing the tool so that the folded edge engages the backside. Place marking utensil in either ⅞″ or 1⅝″ strut marking locations, slide the conduit layout tool along the surface while holding the pen in ⅞″ or 1⅝″ strut marking location, this marks the strut line.
B) Step two turn the conduit layout tool over align the notched side close to and parallel to the strut line. Mark the conduit combination desired 4″ to 3″ etc. slide the conduit layout tool over, align the last conduit marked in the adjacent same size and mark the next size etc.
C) Step three turn the conduit layout tool over position the alignment window over the intersecting marks from steps one and two mark the conduit center for the appropriate size.

2. A one-piece tool that incorporates all trade sizes ½″ through 4″ for a single conduit or a combination of parallel conduit runs.

3. A method of accurately placing electrical conduit holes in a surface of an electrical box to facilitate the installation of electrical conduits therein comprising the steps of one, two and three in which no calculations are needed or used, out side of knowing what sizes will be used.

4. A method of accurately placing electrical conduits on a strut rack in a uniform manner in which coincides with the placement of conduit into a box in the exact same parallel dimensions.

5. A method of accurately placing or identifying electrical wire in a conduit or box in which a circuit location number is to be connected in a specific location, either a 120V or a 277V location.

6. A method of accurately placing electrical conduit holes in a surface of an electrical box according to claim 2, wherein a plurality of hole saws or knockouts of various sizes are used, each having a respective diameter corresponding to the diameter of an electrical conduit to be installed on the surface of the electrical box.
